(19) United States
(12) Patent Application Publication
(10) Pub. No.: US 2026/0044952 A1
(43) Pub. Date: Feb. 12, 2026

(54) METHOD AND SYSTEM FOR OBTAINING MEASUREMENTS OF SEMICONDUCTOR STRUCTURES ON A WAFER

(71) Applicant: Carl Zeiss SMT GmbH, Oberkochen (DE)

(72) Inventors: Dmitry KLOCHKOV, Schwaebisch Gmuend (DE); Anna ALPEROVICH, Neu-Ulm (DE); Anurag KUSHWANSHI, Bihar (IN); Abhilash SRIKANTHA, Neu-Ulm (DE)

(21) Appl. No.: 19/360,250

(22) Filed: Oct. 16, 2025

Related U.S. Application Data
(63) Continuation of application No. PCT/EP2024/058818, filed on Mar. 30, 2024.

(30) Foreign Application Priority Data
Apr. 19, 2023 (DE) 10 2023 109 947.7

(51) Int. Cl. G06T 7/00; G06T 7/246; G06T 7/73

(52) U.S. Cl. CPC G06T 7/001; G06T 7/248; G06T 7/74; G06T 2200/24; G06T 2207/10061; G06T 2207/20092; G06T 2207/30148

(57) ABSTRACT

A method of obtaining measurements of semiconductor structures on a wafer comprises: obtaining a volumetric imaging dataset of the wafer comprising multiple 2D cross section images; obtaining contours of semiconductor structures in 2D cross section images; indicating, in a first 2D cross section image, one or more measurement specifications with respect to features of contours of semiconductor structures; propagating the indicated one or more measurement specifications in the first 2D cross section image to further 2D cross section images; and obtaining measurements of semiconductor structures by evaluating the one or more measurement specifications in the first 2D cross section image and in the further 2D cross section images.

### CROSS-REFERENCE TO RELATED APPLICATIONS

The present application is a continuation of, and claims benefit under 35 USC 120 to, international application No. PCT/EP2024/058818, filed Mar. 30, 2024, which claims benefit under 35 USC 119 of German Application No. 10 2023 109 947.7, filed Apr. 19, 2023. The entire disclosure of each of these applications is incorporated by reference herein.

### FIELD

The disclosure relates to systems and methods for obtaining measurements of semiconductor structures on a wafer. For example, the present disclosure relates to a method for obtaining a volumetric imaging dataset of a wafer comprising semiconductor structures and to a corresponding computer-readable medium, computer program product and system. The method, computer-readable medium, computer program product and system can be utilized for quantitative metrology, defect detection, defect review, critical dimension examination, process window qualification.

### BACKGROUND

Manufacturing of wafers comprising semiconductor structures can involve a complex sequence of deposition and removal of physical substances at nano-scale resolutions. Therefore, extracting measurements such as inter- and intra-structure distances of the manufactured 3D structures is relevant to monitoring the manufacturing processes.

A wafer made of a thin slice of silicon typically serves as the substrate for microelectronic devices containing semiconductor structures built in and upon the wafer. The semiconductor structures are usually constructed layer by layer using repeated processing steps that involve repeated chemical, mechanical, thermal and optical processes. Dimensions, shapes and placements of the semiconductor structures and patterns can be subject to several influences. One step is the photolithography process.

Photolithography is a process used to produce patterns on the substrate. The patterns to be printed on the surface of the substrate are often generated by computer-aided-design (CAD). From the design, each layer a photolithography mask can be generated, which generally contains a magnified image of the computer-generated pattern to be etched into the substrate. The photolithography mask can be further adapted, e.g., using optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks are expected to image increasingly smaller structures onto wafers. The aspect ratio and the number of layers of integrated circuits constantly increases and the structures are growing into third (vertical) dimension. The current height of the memory stacks can exceed a dozen microns. In contrast, the feature size is becoming smaller. The minimum feature size or critical dimension is generally below 10 nm, for example 7 nm or 5 nm, and is approaching feature sizes below 3 nm in near future. While the complexity and dimensions of the semiconductor structures are growing into the third dimension, the lateral dimensions of integrated semiconductor structures are becoming smaller. Producing the small structure dimensions imaged onto the wafer generally involves photolithographic masks or templates for nanoimprint photolithography with ever smaller structures or pattern elements.

On account of the tiny structure sizes of the pattern elements of photolithographic masks or templates and the complex production process of semiconductor structures, it is generally not possible to exclude errors during wafer production. Hence, in semiconductor process control wafer inspection, review, and metrology usually play a role to monitor defects. Traditionally, measurements of 2D semiconductor structures were taken manually by experts. However, due to the three-dimensionality of the semiconductor structures on the wafer, three-dimensional measurements are desired, which allow for a more accurate monitoring of the production process.

To obtain a 3D-imaging dataset, e.g., an imaging dataset comprising multiple 2D cross sections of the wafer, destructive imaging techniques using focused ion beam scanning electron microscopy (FIB-SEM) can be used. The generated imaging datasets are usually dense (e.g., comprising thousands of images) and, therefore, can be challenging with respect to scalability, robustness and repeatability for taking measurements.

For example, WO 2021/083581 A1 discloses a method for measuring shape deviations of 3D HAR structures in FIB-SEM tomography. The method comprises generating a template of cross section image features representing a HAR structure of interest and detecting instances of this template in 2D cross section images of an imaging dataset. The detected instances are assigned to different 3D HAR structures, e.g., based on the distance of the center coordinates of the instances in adjacent 2D cross section images. From the detected instances assigned to the same 3D HAR structure the surface of the 3D HAR structure is reconstructed and parameters characterizing the geometry of the entire semiconductor structure are taken.

However, the method involves a relatively considerable user effort for generating templates of structures of interest, e.g., by hand annotation. In addition, the method is based on finding corresponding structures in different 2D cross section images, which can be error prone, since structures can move or even disappear in different 2D cross section images. In addition, the method involves a 3D surface generation from multiple boundary coordinates, which can be computationally expensive.

US 2020/0173772 A1 discloses a method for generating a 3D-reconstruction of HAR features from a wedge cut using harmonics and Fast Fourier Transforms. Due to the 3D surface generation, the method is generally computationally expensive.

WO 2022/223229 A1 discloses a method for taking measurements of semiconductor structures by detecting contours in cross-section images and analyzing parameters of these contours, i.e., a displacement from an ideal position or a deviation in radius, diameter, area or shape. However, these measurements are not be flexibly indicated or adapted to the desired properties of a user or of an application.

### SUMMARY

The disclosure seeks to provide a computationally relatively fast method for taking measurements of 3D semiconductor structures. The disclosure also seeks to reduce the user effort of such a method. The disclosure also seeks to allow for a relatively simple, fast and flexible definition of the desired measurements by a user and an accurate computation of the defined measurements. Further, the disclosure seeks to improve the accuracy of methods for taking measurements of 3D semiconductor structures. In addition, the disclosure seeks to provide defect detection methods of high accuracy for wafers. The disclosure also seeks to provide a method for reviewing critical dimensions of semiconductor structures on a wafer. Further, the disclosure seeks to provide a method for process window qualification. Moreover, the disclosure seeks to increase the throughput during quality control or quality assurance processes for wafers. The disclosure also seeks to minimize runtimes of quality control.

Embodiments of the disclosure encompass methods, computer-readable media, computer program products and systems for obtaining measurements of semiconductor structures on a wafer.

In a first aspect, the disclosure provides a method, such as a computer implemented method, for obtaining measurements of semiconductor structures on a wafer. The method comprises: a) obtaining a volumetric imaging dataset of the wafer comprising multiple 2D cross section images; b) obtaining contours of semiconductor structures in 2D cross section images of the imaging dataset; c) indicating, in a first 2D cross section image of the imaging dataset, one or more measurement specifications with respect to features of contours of semiconductor structures; d) propagating the indicated one or more measurement specifications in the first 2D cross section image to further 2D cross section images of the imaging dataset; and e) obtaining measurements of semiconductor structures by evaluating the one or more measurement specifications in the first 2D cross section image and in the further 2D cross section images of the imaging dataset.

Instead of obtaining three-dimensional measurements from 3D reconstructions of semiconductor structures, three-dimensional measurements can be obtained from multiple two-dimensional measurements in different 2D cross section images of the imaging dataset. In this way, the computation time can be reduced to a great extent, since computationally intensive 3D reconstructions of semiconductor structures are not used. In addition, the user effort can be reduced, since the measurement specifications are only indicated in a single 2D cross section image and automatically propagated to further 2D cross section images. Thus, there is no need for a time-consuming generation of templates for semi-conductor structures from different 2D cross section images. Since the measurement specifications are automatically propagated to further 2D cross section images, there is no need for error prone heuristics to find instances of the same semiconductor structure in different 2D cross section images.

The obtained measurements of the semiconductor structures can be used in many different ways. For example, tilts or twists of a three-dimensional feature, e.g., a HAR structure such as a memory hole or a pillar, can be measured by interpolating the centroids of the HAR structure in different 2D cross sections by a line and measuring the angle between the interpolated line and a vertical line. In another example, the ellipticity, average radius, inclination, tilt or curvature of a HAR structure's axis, e.g., of a pillar, can be measured by comparing corresponding parameters from the 2D cross section images. In another example, the minimum distance between two three-dimensional HAR structures can be computed by measuring the two-dimensional distance between the two features in different 2D cross section images of the imaging dataset and selecting the smallest distance. In case of a specified baseline value, e.g., a critical dimension value, distances between features or lengths of features can be measured and compared to the baseline value. Based on the obtained measurements defects can be detected. For process window qualification, wafer sections can be generated using a photolithography process with different manufacturing parameters. Then the wafer sections can be reviewed by comparing measurements or detecting defects, and optimal manufacturing parameters can be selected.

The term “defect” refers to a localized deviation of a semiconductor structure from an a priori defined norm of the semiconductor structure. For instance, a defect of a semiconductor structure can result in malfunctioning of an associated semiconductor device. Depending on the detected defect, for example, the photolithography process can be improved, or wafers can be repaired. For example, detected bridge defects indicate insufficient etching, so the amount of etching is increased, detected line breaks indicate excessive etching, so the amount of etching is decreased, consistently occurring defects indicate a defective photolithography mask, so the photolithography mask is checked, and detected missing structures hint at non-ideal material deposition, so the material deposition is modified.

According to an example of the first embodiment of the disclosure, the imaging dataset is obtained by a focused ion beam scanning electron microscope.

According to an example of the first embodiment of the disclosure, the wafer is a memory wafer, for example comprising RAM, DRAM or NAND structures, etc. Due to the simple structure of such memory wafers, measurement specifications can be efficiently indicated in a first 2D cross section image and propagated to further 2D cross section images. Thus, the computation time as well as the user effort can be reduced.

According to an example of the first embodiment of the disclosure, the measurement specifications are from the group comprising feature position, feature distance, feature size. The features of the contours of the semiconductor structures can comprise points, lines or curves defined relative to contours or contour segments of one or more semiconductor structures in the first 2D cross section image. For example, the features of the contours of the semiconductor structures can be from the group comprising points on contours or on contour segments, areas defined by contours or by contour segments, contours or contour segments, centroids of contours or of contour segments. Thus, various dimensions of the semiconductor structures can be measured by indicating measurement specifications with respect to features defined relative to contours or contour segments in the first 2D cross section image. In this way, the flexibility of the method is increased and the user effort reduced. In an example, the measurement specifications are used to indicate critical dimensions of the semiconductor structures to ensure printability on the wafer.

In an example, the measurement specifications in the first 2D cross section image comprise or consist of feature distances, and the features of the contours consist of points defined relative to contours, such as contour points. This means that the measurement specifications in the first 2D cross section image only indicate distances between points defined relative to contours, such as distances between contour points. In this way, the measurement specifications can be indicated in a relatively simple, exact and flexible way, and the propagation of the measurement specifications can be simplified and can involve less computation time.

In an example, the indicated one or more measurement specifications in the first 2D cross section image are propagated to further 2D cross section images of the imaging dataset in step d) by associating the features of the contours of the semiconductor structures in the first 2D cross section image, with respect to which the one or more measurement specifications are defined, with corresponding features in contours of semiconductor structures in the further 2D cross section images.

Instead of re-computing the measurement specifications in each further 2D cross section image, the features of the contours of the semiconductor structures in the first 2D cross section image, e.g., contour points, that define the one or more measurement specifications, can be directly propagated to the further 2D cross section images. In this way, the computation of the measurement specifications can be simplified and relatively fast.

According to an example, the indicated one or more measurement specifications in the first 2D cross section image are propagated to further 2D cross section images of the imaging dataset in step d) by associating the contours of the semiconductor structures in the first 2D cross section image with corresponding contours of the same semiconductor structures in the further 2D cross section images, and by associating the features of the contours of the semiconductor structures in the first 2D cross section image with corresponding features in the associated contours of the semiconductor structures in the further 2D cross section images.

In this way, the propagation of measurement specifications to further 2D cross section images can be carried out relatively fast and automatically, thereby reducing the computation time and the user effort.

In addition, the accuracy of the propagated measurements can be improved, since the measurement specifications or the features are not directly propagated to further 2D cross section images, which could be error prone. Instead, the contours of the semiconductor structures are propagated to further 2D cross section images. The feature points, which are defined relative to the contours, can then be computed from the propagated contours in the further 2D cross section images with sub-pixel accuracy. For example, the measurement specifications comprise measuring the distance of two contour points of semiconductor structures in the 2D cross section images. Instead of propagating each contour point indicated in the first 2D cross section image directly to further 2D cross section images, e.g., using pattern matching, the position of each contour point relative to the contour (e.g., the direction from the centroid of the contour) can be computed. Then associated contours can be obtained in the further 2D cross section images. From these associated contours the contour points can be computed relative to the associated contour (e.g., the contour point lying in the same direction from the centroid of the associated contour). In this way, the two contour points can be computed with sub-pixel accuracy, and the distance between them can be measured with increased accuracy.

Furthermore, the association of contours over the 2D cross section images can be carried out with higher accuracy (e.g., by using tracking algorithms which consider all 2D cross section images at the same time) than by associating contours between each two single images based on heuristics.

According to an example, the contours of the semiconductor structures in the first 2D cross section image and in the further 2D cross section images are obtained by applying a contour extraction method to the first 2D cross section image and to the further 2D cross section images. In this way, the contours of the semiconductor structures in the first 2D cross section image and in the further 2D cross section images can be obtained automatically and with high accuracy, e.g., using machine learning methods.

The contours of the semiconductor structures in the first 2D cross section image and in the further 2D cross section images can be obtained in various ways.

According to an example, the contours of the semiconductor structures in the first 2D cross section image and in the further 2D cross section images are obtained by applying an object detection or image segmentation algorithm to the first 2D cross section image and to the further 2D cross section images. In case of a segmentation algorithm, the contours of the semiconductor structures in the first 2D cross section image and in the further 2D cross section images can be obtained by computing the boundary of the segments obtained by the segmentation algorithm. In case of an object detection algorithm, the contours of the semiconductor structures in the first 2D cross section image and in the further 2D cross section images can either be represented by bounding boxes obtained by the object detection algorithm, or they can be obtained from the object detection results by contour extraction methods, e.g., applied to the obtained bounding boxes. In this way, the contours of the semiconductor structures in the first 2D cross section image and in the further 2D cross section images can be obtained automatically and with relatively high accuracy, e.g., using machine learning methods. The machine learning methods can, for example, be trained on annotated 2D cross section images or on labeled design files or on some kind of standard object detection or segmentation database available on the internet.

According to an example, the contours of the semiconductor structures in the first 2D cross section image and in the further 2D cross section images are obtained by applying an instance segmentation algorithm to the first 2D cross section image and to the further 2D cross section images. Instance segmentation algorithms do not only provide the area of semiconductor structures, but they can also assign an instance number to the detected image segments (e.g., each pillar cross section is assigned a different instance number in the first and the further 2D cross section images). In this way, pixels belonging to the same type of semiconductor structure but to different instances can be distinguished. Thus, the propagation of segmented instances to further 2D cross section images can be simplified, since the segments already correspond to different semiconductor structure instances. Therefore, the accuracy of the method can be improved.

The contours of the semiconductor structures in the first 2D cross section image and in the further 2D cross section images can be represented in different ways, for example as curves or boundaries of areas, etc.

According to an example, the contours of the semiconductor structures in the first 2D cross section image and in the further 2D cross section images are represented by contour points, e.g., by edge pixels of semiconductor structures in 2D cross section images or by subsampling contours. In this way, the representation of the contours can be simplified. This can allow for a relatively fast computation of associated contours and features in further 2D cross section images.

According to an example, the contours of the semiconductor structures in the first 2D cross section image and in the further 2D cross section images are represented by bounding boxes. Bounding boxes are a relatively simple representation of contours, and they are often used as a representation of results of algorithms, e.g., of object detection algorithms. They can allow for a relatively fast and simple computation of associated contours and features in further 2D cross section images, e.g., using tracking algorithms.

The contours of the semiconductor structures in the first 2D cross section image and in the further 2D cross section images can be associated in various ways.

According to an example, associating the contours of the semiconductor structures in the first 2D cross section image to corresponding contours of the same semiconductor structures in the further 2D cross section images comprises computing a matching of contour points of the semiconductor structures in the first 2D cross section image and contour points of the semiconductor structures in the further 2D cross section images, e.g., using the Hungarian algorithm. In this way, the association of contours in the first 2D cross section image and the further 2D cross section images can be computed with high accuracy. In addition, the computation time is reduced, since only single points are matched between different 2D cross section images instead of whole contours or image segments.

According to an example, associating the contours of the semiconductor structures in the first 2D cross section image to corresponding contours of the same semiconductor structures in the further 2D cross section images comprises applying a tracking algorithm or an optical flow algorithm to track the contours of the semiconductor structures in the first 2D cross section image over the further 2D cross section images of the imaging dataset. By using a tracking or optical flow algorithm to track the contours, the association of contours in the first 2D cross section image and the further 2D cross section images can be computed with relatively high accuracy.

In an example, associating the contours of the semiconductor structures in the first 2D cross section image to corresponding contours of the same semiconductor structures in the further 2D cross section images comprises applying a tracking algorithm, wherein the tracking algorithm is configured to minimize the number of interruptions of the obtained trajectories, wherein a trajectory is defined as the path of a contour of a semiconductor structure through consecutive 2D cross section images in the imaging dataset. By minimizing interruptions of trajectories, relatively long trajectories can be obtained, which also comprise associated contours of lower confidence. These contours of lower confidence are often due to defects and should not be excluded from the trajectory. Thus, defects can be detected with higher accuracy by evaluating the one or more measurement specifications.

In an example, an instance segmentation algorithm is used to obtain contours of semiconductor structures in the first 2D cross section image and in the further 2D cross section images. Then a tracking algorithm is used to track each segmented instance from the first 2D cross section image over the further 2D cross section images. In this way, relatively accurate results can be obtained, since tracking can be simplified as the instance segmentation algorithm already provides information on separate semiconductor structure instances.

According to an example, associating the contours of the semiconductor structures in the first 2D cross section image to corresponding contours of the same semiconductor structures in the further 2D cross section images comprises registering the imaging dataset to a reference imaging dataset with labeled contours. In this way, the association of contours in the first 2D cross section image and the further 2D cross section images is computed indirectly via the reference imaging dataset and with relatively high accuracy, since the registration of whole imaging datasets might be accomplished with higher accuracy than the association of single contours due to the additional information contained in the imaging datasets.

According to an example, the contours of the semiconductor structures in the first 2D cross section image and in the further 2D cross section images are obtained by computing a 3D segmentation of the semiconductor structures in the imaging dataset and computing the contours of the segmented semiconductor structures in the first 2D cross section image and in the further 2D cross section images from the 3D segmentation. By using 3D segmentation algorithms for obtaining the contours, the accuracy of the method can be increased for two reasons: firstly, 3D segmentation algorithms rely on information from the whole imaging dataset to compute 3D segmentations, and secondly, the association of contours of different 2D cross section images is inherently given by the 3D segmentation and does not have to be computed separately. Thus, the indicated one or more measurement specifications in the first 2D cross section image can be propagated to further 2D cross section images of the imaging dataset in step d) by associating the contours of the semiconductor structures in the first 2D cross section image with corresponding contours of the same 3D segmentation of the same semiconductor structures in the further 2D cross section images, and by associating the features of the contours of the semiconductor structures in the first 2D cross section image, with respect to which the one or more measurement specifications are defined, with corresponding features in the associated contours of the semiconductor structures in the further 2D cross section images.

According to an example, at least one measurement specification comprises a contour point of a contour of a semiconductor structure, wherein the contour point is defined by a specific point relative to the contour, such as the centroid, and a direction vector indicating the direction of the contour point with respect to the specific point in the first 2D cross section image, and wherein associating the contour point in the first 2D cross section image with a corresponding contour point of an associated contour in a further 2D cross section image comprises computing the intersection point of the associated contour and the direction vector starting at the specific point of the associated contour in the further 2D cross section image. By representing the contour point by a specific point defined relative to the contour and a direction vector in the first 2D cross section image, the propagation of the contour point to further 2D cross section images can be accomplished with higher accuracy, since—independent of the shape of the associated contour—the associated contour point lies in the same direction from the corresponding specific point in all 2D cross section images and can be computed with sub-pixel accuracy.

According to an example, at least one measurement specification comprises the computation of a centroid of a contour of a semiconductor structure in one or more 2D cross section images, wherein the centroid is obtained by analyzing intensity profiles along one-dimensional cross sections of a region (e.g., a bounding box) encompassing the contour in the one or more 2D cross section images. In this way, centroids can be computed with higher accuracy than by deriving them from the contours of the semiconductor structures in the 2D cross section images. For example, centroids can be obtained from symmetry points of intensity profiles, wherein the symmetry points can be computed as the intersection of the intensity profile with its symmetry axis. The computed centroids can, for example, be used in measurement specifications or as specific points for defining the position of contour points on contours as described in the previous paragraph.

According to an example, propagating the indicated one or more measurement specifications in the first 2D cross section image to further 2D cross section images of the imaging dataset in step d) comprises generating a confidence score indicating the reliability of the associated measurement specifications in the first 2D cross section image and the further 2D cross section images. The confidence score can, for example, indicate contour detections or contour associations of low likelihood, e.g., due to invisibility of semiconductor structures. The confidence score can be used, for example, by the contour association algorithm, during defect detection or by subsequent algorithms, which rely on the obtained measurements of the semiconductor structures. Thus, the accuracy of the method or subsequent algorithms can be increased.

According to an example, defects are detected by detecting outliers in measurements obtained by evaluating a measurement specification in the first 2D cross section image and in the further 2D cross section images of the imaging dataset. Alternatively, the variation of the obtained measurements can be analyzed to detect defects.

According to an example, an inspection target, such as a target throughput, is obtained (e.g., by querying a user or loading from memory), and the number of further 2D cross section images and/or the number of measurement specifications is automatically adapted to meet the inspection target. In this way, the algorithm can be adapted to specific inspection targets, i.e., desired properties, of the application. An inspection target can comprise a runtime, a throughput, a limit on resources, etc.

The measurement specifications in the first 2D cross section image can be indicated via a user interface. In this way, a relatively simple and flexible way of indicating measurement specifications can be provided to the user. This method, for example, can allow indication of measurements that can hardly be described without a user interface.

According to an example, the user interface is configured for letting a user indicate measurement specifications by selecting one or more features of contours of semiconductor structures on the first 2D cross section image of the imaging dataset.

In an example, the user interface is configured for assisting the user during the indication of the measurement specifications by automatically computing modifications to selected features of contours of semiconductor structures used to define the measurement specifications.

In an example, the user interface is configured for assisting the user during the selection of the one or more features by computing modifications to the selected one or more features with respect to the contours of the semiconductor structures. The features can be automatically modified or after approval of the user. By computing modifications to the selected one or more features the measurement specifications can be indicated with an increased accuracy, e.g., with sub-pixel accuracy, thereby increasing the accuracy of the method.

According to an example, the method further comprises using a user interface configured for letting a user load measurement specifications from a memory or database and/or to save measurement specifications to a memory or database. In this way, the user effort can be reduced, since saved measurement specifications can be applied to further imaging datasets or similar use-cases.

According to an example, the method further comprises using a user interface configured for proposing measurement specifications to a user, which can be accepted, modified or declined by the user, wherein proposals for measurement specifications are generated from measurement specifications previously indicated by the user. The measurement specifications can be generated from previously indicated measurement specifications for the same imaging dataset and/or from previously indicated measurement specifications for different imaging datasets or use cases. For example, machine learning methods can be used for obtaining proposals for measurement specifications.

According to an example, the method further comprises using a user interface configured for letting a user indicate measurement specifications using natural language processing.

This approach can, for example, be used with an instance segmentation algorithm for contour detection, which assigns an instance number to each detected semiconductor structure in a 2D cross section image. The user can then easily indicate measurements by referring to specific instances of the semiconductor structures in the first 2D cross section image. In this way, the user effort for indicating measurement specifications can be reduced.

According to an example, the method further comprises using a visualization device for visualizing features and/or contours and/or measurement specifications, wherein the visualization indicates the association of features and/or contours and/or measurement specifications to the semiconductor structures. In this way, the user can easily review and verify the measurements obtained by the method, find sources of error, and visually detect defects. Thus, the user effort can be reduced.

According to an example, the method further comprises using a visualization device for visualizing features and/or contours and/or measurement specifications, wherein the features and/or contours and/or measurement specifications in the first 2D cross section image are distinguishable from the propagated features and/or contours and/or measurement specifications in the further 2D cross section images. In this way, the user can relatively easily distinguish between the first 2D cross section image, which is used for indicating measurement specifications, and the further 2D cross section images.

According to an example, the method further comprises using a visualization device for visualizing a 3D representation of propagated measurement specifications. In this way, review and verification of the obtained measurements can be simplified and defects can be visually detected.

According to an example, the method further comprises using a user interface and a visualization device configured for letting a user browse through the 2D cross section images comprising visualized features and/or contours and/or measurement specifications. In this way, review and verification of the obtained measurements can be simplified and defects can be visually detected.

In an example, the method for obtaining measurements of semiconductor structures on a wafer is a computer implemented method.

In an aspect, the disclosure provides a computer-readable medium having stored thereon a computer program executable by a computing device, the computer program comprising code for executing any of the methods according to the first embodiment of the disclosure described above.

In an aspect, the disclosure provides a computer program product comprising instructions which, when the program is executed by a computer, cause the computer to carry out any of the methods according to the disclosure described above.

In an aspect, the disclosure provides a system for obtaining measurements of semiconductor structures on a wafer, wherein the system comprises: an imaging device configured to provide a volumetric imaging dataset comprising multiple 2D cross section images of the wafer; one or more processing devices; and one or more machine-readable hardware storage devices comprising instructions that are executable by one or more processing devices to perform operations comprising any one of the methods of the disclosure. Optionally, the system can comprise a database and/or a user interface and/or a visualization device.

While the examples and embodiments of the disclosure are described with respect to semiconductor wafers, it is understood that the disclosure is not limited to semiconductor wafers, but can for example also be applied to reticles or masks for semiconductor fabrication or to other manufactured objects. Also, the techniques described herein can be used with various 3D imaging techniques such as Xray, CT, etc.

The disclosure described by aspects, examples and embodiments is not limited to such aspects, embodiments and examples but can be implemented by those skilled in the art by various combinations or modifications thereof.

### BRIEF DESCRIPTION OF THE DRAWINGS

FIG. 1 shows a flowchart of a method for obtaining measurements of semiconductor structures on a wafer;

FIG. 2 shows an imaging dataset comprising a first 2D cross section image and further 2D cross section images;

FIG. 3 shows a first 2D cross section image comprising contours of semiconductor structures and three indicated measurement specifications;

FIG. 4 illustrates the definition of a contour point of a circular contour via a specific point and a direction vector;

FIG. 5 shows a 2D cross section image comprising semiconductor structures with detected inaccurate centroids;

FIG. 6 illustrates a method for obtaining centroids in semiconductor structures in 2D cross section images by analyzing intensity profiles;

FIGS. 7A, 7B visualize detection of defects in semiconductor structures by analyzing measurements obtained by evaluating a measurement specification in the first 2D cross section image and in the further 2D cross section images of the imaging dataset;

FIG. 8 illustrates a method according to an example of the first embodiment of the disclosure; and

FIG. 9 schematically illustrates a system according to the fourth embodiment of the disclosure.

### DETAILED DESCRIPTION

In the following, various exemplary embodiments of the disclosure are described and schematically shown in the figures. Throughout the figures and the description, same reference numbers are used to describe same features or components. Dashed lines indicate optional features.

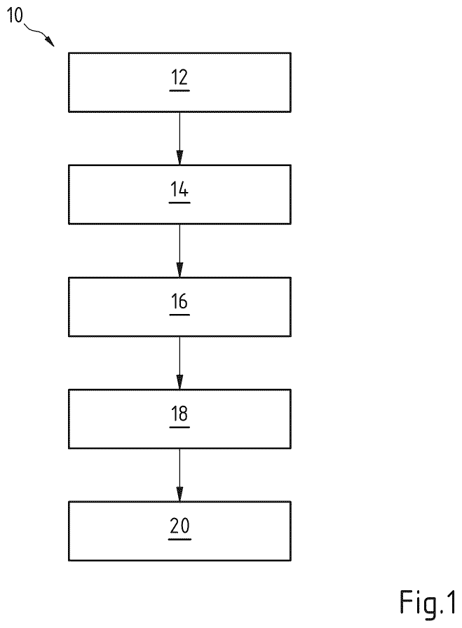

FIG. 1 shows a flowchart of a method 10, such as a computer implemented method, for obtaining measurements of semiconductor structures on a wafer according to a first embodiment of the disclosure. The method comprises obtaining a volumetric imaging dataset of the wafer comprising multiple 2D cross section images in an imaging step 12; obtaining contours of semiconductor structures in 2D cross section images of the imaging dataset in a contour generation step 14; indicating, in a first 2D cross section image of the imaging dataset, one or more measurement specifications with respect to features of contours of semiconductor structures in a measurement specification step 16; propagating the indicated one or more measurement specifications in the first 2D cross section image to further 2D cross section images of the imaging dataset in a propagation step 18; and obtaining measurements of semiconductor structures by evaluating the one or more measurement specifications in the first 2D cross section image and in the further 2D cross section images of the imaging dataset in a measurement step 20.

The method provides measurements of 3D semiconductor structures on a wafer at a low computational cost. Instead of reconstructing the 3D shape of the semiconductor structures, measurement specifications are only indicated in a single 2D cross section image and propagated automatically to further 2D cross section images. In this way, measurements of 3D semiconductor structures can be computed without involving a 3D reconstruction of the semiconductor structures. This approach can involve minimal user effort, since the user only indicates measurement specifications with respect to contours of semiconductor structures in the first 2D cross section image. No template generation is involved. The obtained measurements can, for example, be used for defect detection in semiconductor structures, for verifying critical dimensions or for process window qualification.

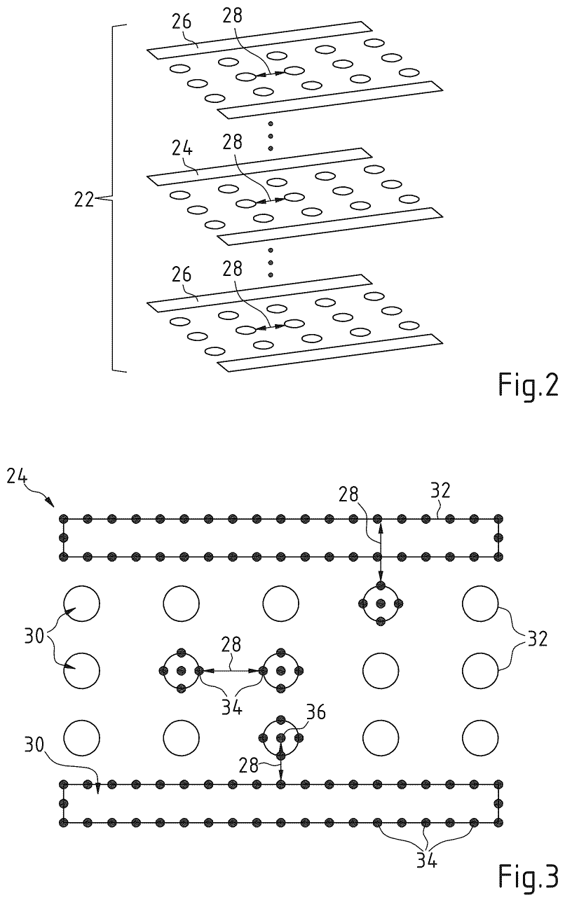

FIG. 2 shows an imaging dataset 22 obtained by a focused ion beam scanning electron microscope (FIB-SEM). The imaging dataset 22 comprises semiconductor structures of a memory wafer. The imaging dataset 22 comprises a first 2D cross section image 24 and further 2D cross section images 26. In the measurement specification step 16, one or more measurement specifications 28 are indicated in the first 2D cross section image 24. In the propagation step 18, the indicated measurement specifications 28 are propagated to the further 2D cross section images 26 of the imaging dataset 22.

FIG. 3 shows a first 2D cross section image 24 comprising contours 32 of semiconductor structures 30 and three indicated measurement specifications 28. The measurement specifications 28 are defined with respect to features of contours 32 of semiconductor structures 30 in the first 2D cross section image 24.

According to an example of the first embodiment of the disclosure, the features comprise specific points, lines or curves defined relative to contours 32 or contour segments of one or more semiconductor structures 30 in the first 2D cross section image 24, such as points on contours (contour points 34) or contour segments, areas defined by contours or contour segments, contours or contour segments, centroids 36 of contours or contour segments, etc. The specific points, lines or curves can be computed from the coordinates of the contours 32 or contour segments of the one or more semiconductor structures 30 in the first 2D cross section image 24. Contour segments refer to parts of contours 32, e.g., defined by an intersecting line, curve, axis or geometric shape with respect to one or more contours 32, for example a part of a contour 32 relative to a symmetry axis, or a part of a contour 32 above or below an intersecting line of a contour 32, or a part of a contour 32 contained in a circle of a specific diameter around the centroid 36 of one or more contours 32, or a part of a contour 32 contained in a bounding box of a specific size centered in the centroid 36 or some other point relative to one or more contours 32, etc.

The features can comprise, for example, points, lines or curves defined relative to a single contour 32, e.g., contour points 34 or centroids 36 as shown in FIG. 3, points on a circumcircle or a bounding box of a contour 32 or contour segment, diameters or chords of contours 32 or contour segments, circumcircles or bounding boxes of contours 32 or contour segments, etc.

The features can comprise, for example, points, lines or curves defined relative to two or more contours 32 or contour segments, e.g., points lying on a connecting line between two centroids 36 of contours 32 or contour segments, points lying in the center of two or more contours 32 or contour segments, contour points on different contours with minimal distance between them, connecting lines, intersecting lines or symmetry axes between contours 32 or contour segments, etc.

According to an example of the first embodiment of the disclosure, the measurement specifications 28 are from the group comprising feature position, feature distance, feature size. The measurement specifications 28 are used to obtain 2D measurements of cross sections of semiconductor structures 30 within the first 2D cross section image 24 and the further 2D cross section images 26. The measurement specifications 28 can comprise the position of a feature, e.g., the coordinate of the feature in a coordinate system, or the angle of the feature with respect to some line or the position of the feature with respect to a specific landmark in the first and/or the further 2D cross section images 24, 26, e.g., with respect to a specified point, line or plane. The measurement specifications 28 can comprise feature distances. The distances can be measured using different norms, e.g., an Lₚ-norm, or the distances can be measured on a contour (e.g., the distance of two points on a contour can be measured by the length of the contour segment connecting the two points). Feature distances can comprise shortest distances of features on one or more contours 32 or shortest distances of features with respect to specified points (e.g., landmarks), lines, curves or planes. The measurement specifications 28 can comprise the size of a feature, e.g., a contour area or contour segment area, or the length of a contour or a contour segment, or the length of a radius or diameter or of any other line or curve defined relative to one or more contours (e.g., a line or curve connecting two points of a contour, or a line or curve connecting points of two or more contours), or the area or length of a circumcircle or bounding box containing one or more contours. The indicated measurement specifications 28 in FIG. 3, for example, define distances between contour points 34 or between a contour point 34 and a centroid 36.

In an example, the measurement specifications 28 in the first 2D cross section image 24 indicate only distances between points defined relative to contours 32, for example between contour points 34. A distance between two points can, for example, be indicated by a line connecting the two points as shown in FIG. 3. In this way, a particularly simple, efficient and flexible way for indicating measurement specifications 28 is given. For example, distances that can hardly be described in any other way can be indicated in this way.

According to an example of the first embodiment of the disclosure, the indicated one or more measurement specifications 28 in the first 2D cross section image 24 are propagated to further 2D cross section images 26 of the imaging dataset 22 in step d) by associating the contours 32 of the semiconductor structures 30 in the first 2D cross section image 24 with corresponding contours 32 of the same semiconductor structures 30 in the further 2D cross section images 26, and by associating the features of the contours 32 of the semiconductor structures 30 in the first 2D cross section image 24 with corresponding features in the associated contours 32 of the semiconductor structures 30 in the further 2D cross section images 26. Thus, measurement specifications 28, which are defined with respect to features of contours 32 of semiconductor structures in the first 2D cross section image 24, can be automatically transferred to further 2D cross section images 26 by associating the features of the contours 32 with corresponding features of corresponding contours 32 in the further 2D cross section images 26. Thus, measurements are propagated fully automatically to the further 2D cross section images 26 as shown in FIG. 2. The measurement specifications 28 are also propagated with high accuracy, since the features of the contours are computed from the associated contours, which can be accomplished with sub-pixel accuracy.

The contours 32 of the semiconductor structures 30 in the first 2D cross section image 24 and in the further 2D cross section images 26 can be obtained in various ways.

According to an aspect of the example of the first embodiment of the disclosure, the contours of the semiconductor structures in the first 2D cross section image and in the further 2D cross section images are obtained by applying a contour extraction method to the first 2D cross section image and to the further 2D cross section images. Numerous contour extraction methods are known to the person skilled in the art. Contour extraction methods can, for example, comprise edge detection methods based on image gradients or filters, e.g., the Canny edge detector, the Sobel edge detector, the Robert's edge detector, or Gabor filters. Contour extraction methods can also comprise active contours or snakes, which can be used to obtain closed contours by minimizing the length and/or the curvature of the contour and simultaneously adapting the contour to image edges. Connected contours can also be obtained from edge detections using random walk techniques. Contour extraction methods can also comprise segmentation approaches such as superpixel segmentation methods or watershed methods. Distance transform images measure the distance of each pixel from edges in the images. Thus, the zero-contours in the distance transform images indicate contours. Contour extraction methods can also comprise model-based contour extraction methods for the detection of contours belonging to specific objects, e.g., specific semiconductor structures, if prior knowledge is available. Machine learning models can be trained to detect edges in general. Machine learning models can also be trained to detect object specific edges, e.g., to detect only those edges in an image, which belong to a specific type of object, for example to a specific type of semiconductor structure.

According to an aspect of the example of the first embodiment of the disclosure, the contours 32 of the semiconductor structures 30 in the first 2D cross section image 24 and in the further 2D cross section images 26 are obtained by applying an object detection or image segmentation algorithm to the first 2D cross section image 24 and to the further 2D cross section images 26. The boundaries of the detected objects or, respectively, the boundaries of the image segments represent the contours in first and the further 2D cross section images 24, 26. Object detection and image segmentation methods are known to the person skilled in the art.

Object detection methods deal with detecting instances of semantic objects of a certain class in images. Classical object detection methods mostly rely on a specific set of features which characterize the objects of interest, e.g., SIFT (scale invariant feature transform) features or HOG (histogram of oriented gradients) features. Based on these feature vectors, a classification algorithm, e.g., a support vector machine or a neural network, can be trained to distinguish feature vectors belonging to the objects of interest from feature vectors of other objects or background. Pattern recognition approaches can also be used for object detection, e.g., Hough-Transforms, for example for detecting simple geometric shapes such as circles or rectangles, which are typical for cross sections of semiconductor structures. Modern object detection methods are mostly based on machine learning models, e.g., on deep learning models such as convolutional neural networks. During training, deep learning models automatically learn filters to generate features from the images which are best suited to solve the object detection task.

Image segmentation is typically used to locate objects and boundaries in images by partitioning an image into multiple image segments. More precisely, image segmentation is the process of assigning a label to every pixel in an image such that pixels with the same label share certain characteristics. Classical image segmentation methods group pixels together in a segment based on some kind of features, e.g., intensity, color or texture. For example, thresholding or clustering methods can be used, which assign pixels to the closest cluster with respect to the features. Region-growing methods such as watershed or superpixel segmentation methods can be used as well to automatically assign pixels to image segments. Histogram based image segmentation methods are very efficient and can handle intensity variations. Image segmentation methods can take into account image edges by favoring segment boundaries coinciding with image edges. Energy minimization methods, e.g., based on solving partial differential equations such as variational methods or based on graph partitioning methods such as Markov random fields, can be used to minimize an objective function comprising, e.g., a feature similarity term to favor segments sharing the same features and an edge term to favor the coincidence of image edges and segment edges, while ensuring at the same time minimum length and/or curvature of the boundaries. Model-based image segmentation methods can be used if prior knowledge is available for the objects of interest, e.g., pattern recognition approaches. Such pattern recognition approaches are especially useful for segmenting simple geometric shapes, e.g., if the semiconductor structures are circular and/or rectangular. Modern approaches to image segmentation are mostly based on machine learning models, e.g., deep learning models, which derive their own set of features optimal for solving the image segmentation task during the training phase. Deep learning models can, for example, be based on U-net architectures.

According to an example of the first embodiment of the disclosure, the contours 32 of the semiconductor structures 30 in the first 2D cross section image 24 and in the further 2D cross section images 26 are obtained by applying an instance segmentation algorithm to the first 2D cross section image 24 and to the further 2D cross section images 26.

Instance segmentation is the task of detecting and delineating each distinct object of interest appearing in an image. Thus, instance segmentation algorithms do not only compute a semantic segmentation of the image (e.g., a labeling of the image with different classes such as “semiconductor structure” or “background”), but additionally retrieve different instances of the same object class, e.g., by assigning a specific index to each object of the same class. Instance segmentation algorithms, thus, compute for pixels of the image 1) the object class and 2) the number of the object instance the pixel belongs to. To simplify the task, prior knowledge can be available for the objects of interest, e.g., the type and appearance of the semiconductor structures of interest. Instance segmentations can be computed, for example, using machine learning models. Machine learning models can, for example, be trained on user annotations or on design files containing labeled models of semiconductor structures. They can also be trained on segmentation results, e.g., on superpixel labelings, contour extraction results or watersheds, etc. To improve the performance of the machine learning model hyperparameter optimization and/or neural network architecture search approaches can be employed.

Various machine learning models can be used for instance segmentation, for example deep learning approaches, reinforcement learning approaches and Transformers. A Transformer machine learning model suitable for instance segmentation is called “Masked-attention Mask Transformer” and relies on the classification of image segments represented by C-dimensional feature vectors called “object query”, which can be processed by a Transformer decoder trained with a set prediction objective. A simple meta-architecture can consist of three components. A backbone that extracts low resolution features from an image. A pixel decoder that gradually upsamples low-resolution features from the output of the backbone to generate high-resolution per-pixel embeddings. And a Transformer decoder that operates on image features to process object queries. The final binary mask predictions are decoded from per-pixel embeddings with object queries. The Transformer decoder can include a masked attention operator, which extracts localized features by constraining cross-attention to within the foreground region of the predicted mask for each query, instead of attending to the full feature map.

To handle small objects, an efficient multi-scale strategy to utilize high-resolution features can be adopted. It feeds successive feature maps from the pixel decoder's feature pyramid into successive Transformer decoder layers in a round robin fashion. Alternative machine learning models for instance segmentation are, for example, deep learning models such as Mask R-CNN, YOLACT or TensorMask.

The contours 32 of the semiconductor structures 30 in the first and the further 2D cross section images 24, 26 can be represented in various ways.

In any of the examples described herein, the contours 32 of the semiconductor structures 30 in the first 2D cross section image 24 and in the further 2D cross section images 26 can be represented by contour points 34. The contour points are, thus, points lying on the contours of the semiconductor structures 30. The contour points 34 can be obtained, for example, by subsampling the contours 32 of the semiconductor structures 30 in the first and the further 2D cross section images 24, 26 with a specific density, as shown for example in FIG. 3. Alternatively, contour points 34 can be obtained by detecting edge pixels of semiconductor structures 30 in the first and the further 2D cross section images 24, 26.

In any of the examples described herein, the contours 32 of the semiconductor structures 30 in the first 2D cross section image 24 and in the further 2D cross section images 26 can be represented by bounding boxes. The bounding boxes can have various shapes encompassing the semiconductor structures 30 in the first and the further 2D cross section images 24, 26, e.g., rectangular, circular, elliptical or any other kind of shape.

Contour points 34 can be obtained from bounding boxes by subsampling the lines of the bounding boxes. In case of rectangular bounding boxes, the edges of the bounding boxes can be used as contour points 34.

Associating the contours 32 of the semiconductor structures 30 in the first 2D cross section image 24 to corresponding contours of the same semiconductor structures in the further 2D cross section images 26 can be accomplished in various ways.

According to an aspect of the example of the first embodiment of the disclosure, associating the contours 32 of the semiconductor structures 30 in the first 2D cross section image 24 to corresponding contours of the same semiconductor structures in the further 2D cross section images 26 comprises computing a matching of contour points 34 of the semiconductor structures 30 in the first 2D cross section image 24 and contour points 34 of the semiconductor structures 30 in the further 2D cross section images 26. This is especially useful if the contours 32 of the semiconductor structures 30 in the first and the further 2D cross section images 24, 26 are represented by contour points 34 as described above. Such contour points 34 of contours 32 in 2D cross section images 24, 26 can be obtained in different ways, e.g., by subsampling contours 32 of semiconductor structures, using an edge detection algorithm, or using a machine learning algorithm. If the contours 32 are represented by contour points 34, associating contours 32 in different 2D cross section images 24, 26 involves finding a matching of contour points 34 in different 2D cross section images 24, 26, e.g., using the Hungarian algorithm. The Hungarian algorithm is a combinatorial optimization algorithm known to the person skilled in the art that solves the assignment problem in polynomial time. The assignment problem consists of finding, in a weighted bipartite graph, a matching of a given size, in which the sum of weights of the edges is minimum. Applied to the association of contour points 34 of contours 32 in 2D cross section images 24, 26, the nodes of the graph are the contour points 34 and the edges of the graph represent possible associations between contour points 34 of different 2D cross section images 24, 26. The weighting of the edges of the graph can be defined with respect to the distance of the contour points 34 in the first and the further 2D cross section images 24, 26.

According to an aspect of the example of the first embodiment of the disclosure, associating the contours 32 of the semiconductor structures 30 in the first 2D cross section image 24 to corresponding contours 32 of the same semiconductor structures 30 in the further 2D cross section images 26 comprises applying a tracking algorithm or an optical flow algorithm to track the contours 32 of the semiconductor structures 30 in the first 2D cross section image 24 over the further 2D cross section images 26 of the imaging dataset 22.

Tracking algorithms are known to a person skilled in the art. They predict future positions of one or more moving objects based on the history of the individual positions of the one or more moving objects. The contours 32 of the semiconductor structures 30 in the first 2D cross section image 24 can be used to initialize the tracking algorithm, which then tracks the contours 32 over the further 2D cross section images 26. Tracking algorithms can rely on results of object detection algorithms, which are applied to the first and the further 2D cross section images 24, 26 to obtain object indicators such as, e.g., bounding boxes, contours or centroids of objects of interest or the segments obtained by an instance segmentation algorithm as described above. In this case, the tracking algorithm finds a trajectory of object indicators through the first and the further 2D cross section images 24, 26 according to some optimization criterion, e.g., the spatial distance of object indicators between different 2D cross section images or the similarity of the object indicators in the image according to some similarity metric, e.g., color, intensity, texture, shape similarity, size, etc. Using the trajectory, contours 32 can be associated through different 2D cross section images by following the trajectories. Other tracking algorithms do not use results of an object detection algorithm, e.g., Kalman filters.

Especially for tracking contours 32 of semiconductor structures 30 through different 2D cross section images 24, 26, which can contain defects, it is desirable to prevent interruptions of trajectories due to irregularities in 2D cross section images 24, 26 caused by defects. It is, in fact, exactly these irregularities that lead to irregular measurements in the measurement specifications and, thus, are used to detect defects in the semiconductor structures 30. To this end it is desirable to associate (almost) every contour 32 (e.g., bounding box) in the first and the further 2D cross section images 24, 26 to a trajectory. In contrast to common object detection methods, which discard contours 32 with low similarity metrics, it is desirable to also consider contours 32 with low similarity metrics, which can be due to defects in the first and the further 2D cross section images 24, 26. In a first step, contours 32 with high similarity metrics are associated to trajectories of different semiconductor structures 30. In a second step, contours 32 of low similarity metrics are assigned to the trajectories. In the second step, instead of using similarity metrics based on appearance for the assignment of contours of low similarity metrics to trajectories, the overlap of the area of the contours 32 in the different 2D cross section images 24, 26 is used (intersection over union metric). The more the area of a contour 32 with low similarity metric overlaps with the area of a contour 32 already assigned to a trajectory (especially for adjacent 2D cross section images 24, 26) the more likely the contour 32 with the low similarity metric belongs to the same trajectory. In addition, the course of the trajectory can be analyzed to find contours 32 with low similarity metrics which are likely to belong to the same trajectory.

Instead of preventing interruptions of trajectories due to irregularities in 2D cross section images 24, 26, these interruptions of trajectories can be detected to detect defects in semiconductor structures 30 in 2D cross section images 24, 26. Such interruptions can, for example, be found by analyzing the course of the trajectories of contours 32 (e.g., bounding boxes).

Optical flow algorithms are known to a person skilled in the art. Optical flow refers to a displacement field indicating the motion between two or more 2D cross section images 24, 26. Based on an optical flow field, which indicates the displacement between consecutive 2D cross section images, contours 32 or features of contours 32 in a first 2D cross section image 24 can be associated with contours 32 or features of contours 32 in further 2D cross section images 26.

According to an aspect of the example of the first embodiment of the disclosure, associating the contours 32 of the semiconductor structures 30 in the first 2D cross section image 24 to corresponding contours 32 of the same semiconductor structures 30 in the further 2D cross section images 26 comprises registering the imaging dataset 22 to a reference imaging dataset with labeled contours 32. Since the association of contours 32 of semiconductor structures in 2D cross section images in the reference imaging dataset is known, the association information can be transferred from the contours 32 in the reference dataset to the registered contours in the imaging dataset 22.

According to an example of the first embodiment of the disclosure, the contours 32 of the semiconductor structures 30 in the first 2D cross section image 24 and in the further 2D cross section images 26 are obtained by computing a 3D segmentation of the semiconductor structures 30 in the imaging dataset 22 and computing the contours 32 of the segmented semiconductor structures in the first 2D cross section image 24 and in the further 2D cross section images 26 from the 3D segmentation.

3D segmentation methods can be obtained by generalizing 2D segmentation methods to volumetric imaging datasets. For example, a volumetric voxel representation can be obtained from the first and the further 2D cross section images 24, 26 of the imaging dataset 22, and the segmentation methods can be applied to voxels instead of pixels. For example, energy minimization methods or machine learning models as described above can be used for 3D segmentation as well. A surface mesh of the segmented semiconductor structures comprising voxels can then be obtained using the Marching Cubes algorithm. Contours 32 of semiconductor structures 30 can be obtained as the intersection of the voxel-based 3D segmentation or the surface mesh with the 2D cross section image planes.

The obtained 3D segments (voxels or surface mesh segments) within the imaging dataset 22 naturally already contain the information, which contours in the first and the further 2D cross section images 24, 26 belong to the same 3D segment. Thus, the 3D segmentation can be used to associate the contours 32 in the first and the further 2D cross section images 24, 26, which belong to the same semiconductor structure 30. Therefore, the indicated one or more measurement specifications 28 in the first 2D cross section image 24 can be propagated to further 2D cross section images 26 of the imaging dataset 22 in step d) by associating the contours 32 of the semiconductor structures 30 in the first 2D cross section image 24 with corresponding contours 32 of the same 3D segmentation of the same semiconductor structures 30 in the further 2D cross section images 26, and by associating the features of the contours 32 of the semiconductor structures 30 in the first 2D cross section image 24 with corresponding features in the associated contours of the semiconductor structures 30 in the further 2D cross section images 26.

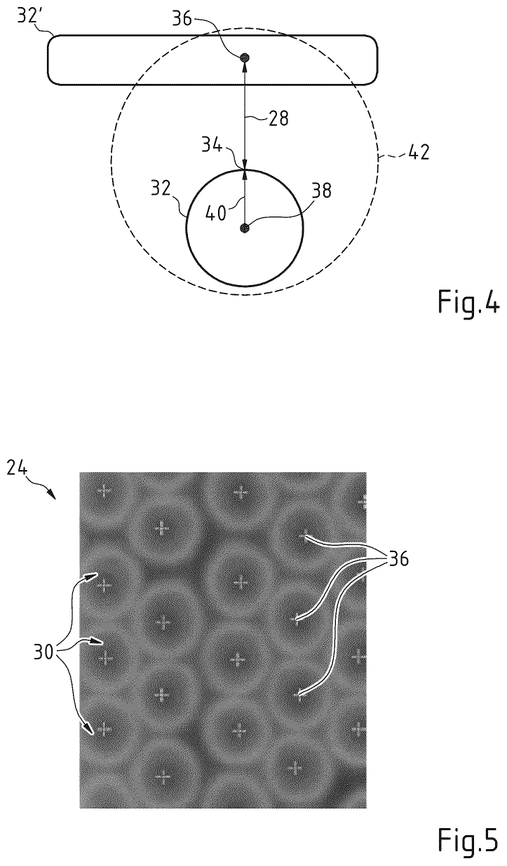

The association of features of contours in different 2D cross section images 24, 26 can be difficult, especially for contour points 34. Associating two contour points 34 on contours 32 in two 2D cross section images 24, 26 involves an accurate detection and association of the contours 32 and of the location of the contour point 34 on the contour 32. To associate contour points 34 with high accuracy, in an example according to the first embodiment of the disclosure illustrated in FIG. 4, at least one measurement specification 28 comprises a contour point 34 of a contour 32 of a semiconductor structure 30, wherein the contour point 34 is defined by a specific point 38 relative to the contour 32, such as the centroid 36, and a direction vector 40 indicating the direction of the contour point 34 with respect to the specific point 38 in the first 2D cross section image 24, and wherein associating the contour point 34 in the first 2D cross section image 24 with a corresponding contour point 34 of an associated contour 32 in a further 2D cross section image 26 comprises computing the intersection point of the associated contour 32 and the direction vector 40 starting at the specific point 38 of the associated contour 32 in the further 2D cross section image 26. Thus, instead of directly associating contour points 34 in different 2D cross section images 24, 26, contour points 34 in different 2D cross section images 24, 26 are associated by 1) defining the contour point 34 with respect to a specific point 38 of the contour 32, e.g., a centroid 36, and a direction vector 40 relative to the specific point 38 in the first 2D cross section image, 2) obtaining an associated contour in each of the further 2D cross section images 26 as described above, 3) for each associated contour in a further 2D cross section image 26, computing the specific point 38 from the associated contour 32, and 4) for each associated contour in the further 2D cross section images 26, calculating the associated contour point 34 as the intersection point of the associated contour 32 and the direction vector 40 starting at the computed specific point 38 of the associated contour. In this way, measurement specifications 28 can be transferred between 2D cross section images 24, 26. In FIG. 4, the measurement specification 28 comprises, for example, the distance between a contour point 34 of a first contour 32 and a centroid 36 of a segment of a second contour 32′. The segment of the second contour 32′ is defined as the part of the contour lying within the circle 42 centered at the contour point 34. The measurement specification 28 can then be transferred to further 2D cross section images 26 by 1) computing the associated contour point in the further 2D cross section images 26 as described above and 2) computing the centroid of the segment of the associated second contour 32′ lying within the circle 42 centered at the associated contour point 34. By computing the associated features of the contours in each further 2D cross section image 26 from the associated contours (e.g., the contour point 34 of the first contour 32 and the centroid 36 of the segment of the second contour 32′) instead of matching single features, the measurement specifications 28 can be transferred to the further 2D cross section images 26 with high accuracy.

The accurate computation of centroids 36 of contours 32 of semiconductor structures 30 in 2D cross section images 24, 26 can be difficult as well. For example, if the contours 32 are represented by contour points 34 or bounding boxes of any shape, the computation of the centroid 36 from the contour 32 itself is difficult. In addition, the contours 32 in the first and the further 2D cross section images 24, 26 can be inaccurate due to various reasons, which makes an accurate computation of the centroid 36 of the contour 32 difficult. FIG. 5 shows a 2D cross section image 24, 26 comprising semiconductor structures 30 with detected inaccurate centroids 36.

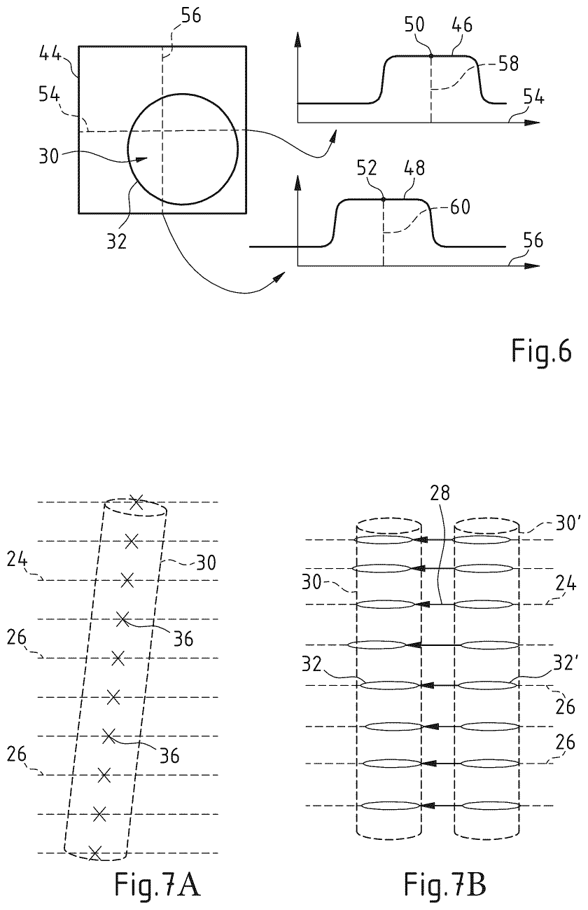

In order to detect centroids 36 of semiconductor structures 30 in 2D cross section images with high accuracy, in an example according to the first embodiment of the disclosure illustrated in FIG. 6, at least one measurement specification 28 comprises the computation of a centroid 36 of a contour 32 of a semiconductor structure 30 in one or more 2D cross section images 24, 26, wherein the centroid 36 is obtained by analyzing intensity profiles 46, 48 along one-dimensional cross sections 54, 56 of a region 44 encompassing the contour 32, e.g., a bounding box, in the one or more 2D cross section images 24, 26. FIG. 6 shows the intensity profile 46 along the horizontal one-dimensional cross section 54 within the region 44 encompassing the contour 32 in the upper diagram, wherein the coordinates along the horizontal one-dimensional cross section 54 are indicated on the horizontal axis and the corresponding image intensity on the vertical axis. The intensity profile 48 along the vertical one-dimensional cross section 56 within the region 44 encompassing the contour 32 is shown in the lower diagram, wherein the coordinates along the vertical one-dimensional cross section 56 are indicated on the horizontal axis and the corresponding image intensity on the vertical axis. The centroid 36 can then, for example, be detected by finding symmetry points 50, 52 of the intensity profiles 46, 48. The symmetry point 50, 52 of an intensity profile 46, 48 is the intersection of the intensity profile 46, 48 with its symmetry axis 58, 60. The symmetry axis 58, 60 of an intensity profile 46, 48 can, for example, be found by computing a cross-correlation of the intensity profile 46, 48 with a flipped version of the same intensity profile 46, 48. The maximum cross-correlation value then indicates the coordinate of the symmetry axis 58, 60 and, thus, the coordinate of the centroid 36. In case the contours 32 are represented by bounding boxes of any shape the bounding boxes can be used as regions 44 encompassing the contour 32. In case the contours 32 are represented by contour points, contour curves or contour segments of semiconductor structures 30 a region 44 encompassing the contour can, for example, be obtained by computing a bounding box of any shape from the coordinates of the contour points, contour curves or contour segments, e.g., by computing the minimum and maximum horizontal and vertical coordinates of the contour. To improve the accuracy of the centroid 36 the bounding box can be centered in the computed centroid and the procedure can be repeated once or several times or until convergence.

Centroids 36 of contours 32 found according to the described method can be used in different ways for obtaining measurements of semiconductor structures 30, e.g., as features of contours 32 for defining measurement specifications 28, or as specific points 38 for defining the location of contour points 34 on contours 32 via a specific point 38 and a direction vector 40 as described above, or whenever centroids 36 of contours 32 of semiconductor structures 30 are to be found in the first or further 2D cross section images 24, 26.

According to an example of the first embodiment of the disclosure, propagating the indicated one or more measurement specifications 28 in the first 2D cross section image to 24 further 2D cross section images 26 of the imaging dataset 22 in step d) comprises generating a confidence score indicating the reliability of the associated measurement specifications 28 in the first 2D cross section image 24 and the further 2D cross section images 26. In this way, uncertainty in the detection or association of contours 32 and/or feature points within different 2D cross section images 24, 26 can be measured and used in further processing steps or subsequent algorithms. For example, contours detected with high uncertainty can be ignored or weighted during the propagation of contours to further 2D cross section images. For example, propagated measurement specifications can be ignored in the evaluation of measurement specifications 28 in case of a low confidence score (e.g., due to high uncertainty of associated contours or features), or the corresponding measurements can be weighted according to the confidence score. This can, for example, be relevant if semiconductor structures 30 are invisible within one or more 2D cross section images, e.g., in case of a partially hollow and, thus, partially invisible semiconductor structure 30 due to a faulty deposition process, or in case of an interrupted semiconductor structure 30 due to some defect. Subsequent algorithms can process the obtained measurements with increased accuracy if a confidence score is additionally indicated.

According to an example of the first embodiment of the disclosure, defects are detected by detecting outliers in measurements obtained by evaluating a measurement specification 28 in the first 2D cross section image 24 and in the further 2D cross section images 26 of the imaging dataset 22. Outliers can, for example, be detected statistically, e.g., by computing a confidence interval or p-values from the obtained measurements. Outliers can also be detected by defining thresholds for the obtained measurements, e.g., minimum or maximum values of measurements or thresholds specified by a user or with respect to the standard deviation of the obtained measurements. Defects can be detected by applying a machine learning model to a list of obtained measurements. The list can, e.g., comprise measurement values obtained by evaluating the measurement specifications, or the list can comprise 3D locations of the features defining the measurement specifications. The machine learning model can be trained to discriminate lists of measurements of semiconductor structures without defects from lists of measurements of semiconductor structures including defects. Defects can also be detected visually by a user. In another example, defects are detected by analyzing the variation of measurements obtained by evaluating a measurement specification 28 in the first 2D cross section image 24 and in the further 2D cross section images 26 of the imaging dataset 22. The larger the variation of the obtained measurements, the more likely an outlier or a defect is present in the corresponding semiconductor structure 30 on the wafer. The variation of the obtained measurements can, for example, be estimated using the variance or standard deviation of the obtained measurements.

FIGS. 7A and 7B visualize the detection of defects in semiconductor structures 30 by analyzing measurements obtained by evaluating a measurement specification 28 in the first 2D cross section image 24 and in the further 2D cross section images 26 of the imaging dataset 22. FIG. 7A shows a tilted semiconductor structure 30. A first 2D cross section image 24 and further 2D cross section images 26 are acquired of the semiconductor structure 30. A measurement specification 28 comprising the position of the centroid 36 of the contour 32 of the semiconductor structure 30 is indicated in the first 2D cross section image 24. The contours 32 in the first and the further 2D cross section images 24, 26 are associated and centroids 36 of the associated contours 32 are computed in the first and the further 2D cross section images 24, 26 (e.g., by analyzing intensity profiles along one-dimensional cross sections as described above). The indicated measurement specification 28 can be evaluated by measuring the position of the centroids 36 in the first and the further 2D cross section images 24, 26. Defects can, for example, be detected by specifying one or more thresholds for the distance of the position of the centroid 36 in a further 2D cross section image 26 from the position of the centroid 36 in the first 2D cross section image 24. Alternatively, the variance of the positions of the centroids 36 in the first and the further 2D cross section images 24, 26 can be measured and used as defect indicator. Alternatively, the angle of the line connecting the centroids 36 and a vertical reference line intersecting the centroid 36 of the contour 32 in the first 2D cross section image 24 can be computed and an angle threshold can be specified to detect defects.

FIG. 7B shows a first model semiconductor structure 30 and a second model semiconductor structure 30′ according to a design file. The indicated first contours 32 in 2D cross section images 24, 26 correspond to the first model semiconductor structure 30 after printing onto a wafer. The indicated second contours 32′ in the 2D cross section images 24, 26 correspond to the second model semiconductor structure 30′ after printing onto the wafer. A measurement specification 28 is defined with respect to the closest contour points of the first contours 32 and the second contours 32′. Defects can then be detected by analyzing the evaluated measurement specification 28, that is the distance between the closest contour points in each 2D cross section image 24, 26, e.g., by detecting outliers. Outliers can, for example, be detected by computing a confidence interval or by comparing each distance to a predefined threshold or to a threshold defined with respect to the mean u and the standard deviation σ of the distances, e.g., [μ−3 σ, μ+3 σ].

The detected defects can finally be visualized to the user, e.g., by highlighting one or more measurement specifications 28 corresponding to defects in the first 2D cross section image 24 and/or in the further 2D cross section images 26. In addition, measurements obtained by evaluating the one or more measurement specifications 28 in the first 2D cross section image 24 and/or in the further 2D cross section images 26 can be displayed to the user.

According to an example of the first embodiment of the disclosure, an inspection target, such as a target throughput, is obtained, and the number of further 2D cross section images 26 and/or the number of measurement specifications 28 is automatically adapted to meet the inspection target. For example, a specific timespan can be provided for the analysis of an imaging dataset 22. In order to meet this desired property, the number of further 2D cross section images can be automatically subsampled, or the number of measurement specifications 28 can be automatically reduced to save computation time.

According to an example of the first embodiment of the disclosure, the measurement specifications in the first 2D cross section are indicated with a user interface. For example, the measurement specifications are graphically marked in the first 2D cross section image via the user interface.

According to an example, the user interface is configured for letting a user indicate measurement specifications 28 by selecting one or more features of contours 32 of semiconductor structures 30 on the first 2D cross section image 24 of the imaging dataset 22. Features can, for example, be indicated by simple click-pointing on the first 2D cross section image 24. In this way, points can be marked, contours or contour parts can be selected, etc. Measurement specifications can, for example, be indicated by click-pointing two or more points, by clicking on specific symbols near a contour, etc. For example, distances can be indicated by marking two points or by connecting points by a line, contour areas can be selected by clicking on a specific symbol displayed near a contour, etc.

The user interface can be configured for assisting the user during the selection of the one or more features by computing modifications to the selected one or more features with respect to the contours 32 of the semiconductor structures 30. For example, contour points indicated by the user can be automatically corrected by moving the indicated contour point to the closest contour point 34 on a contour 32 of a semiconductor structure 30, or centroids 36 indicated by the user can be automatically corrected by moving the indicated centroid to the closest centroid 36 of a contour 32 of a semiconductor structure 30 (e.g., computed by analyzing intensity profiles along one-dimensional cross sections as described above). The user can be asked for confirmation before modifying the selected one or more features. Alternatively, the one or more features can be modified automatically.

According to an example of the first embodiment of the disclosure, the method comprises using a user interface configured for letting a user load measurement specifications 28 from a memory or database and/or to save measurement specifications 28 to a memory or database. For example, a design file with pre-indicated measurement specifications 28 can be loaded and the measurement specifications 28 can be transferred to the first 2D cross section 24 of the imaging dataset automatically, e.g., by a registration method. In an example, after taking measurements of semiconductor structures of a wafer, the indicated measurement specifications 28 can be saved to a memory or database. The user interface can be configured to directly evaluate measurement specifications 28 indicated by a user in the background, while letting the user indicate further measurement specifications 28 (streaming mode). The user interface can be alternatively configured to let the user annotate multiple measurement specifications 28 of interest before starting the evaluation (batch mode).

According to an example of the first embodiment of the disclosure, the method comprises using a user interface configured for letting a user analyze propagated measurement specifications 28 and/or the measurements obtained by evaluating the propagated measurement specifications 28. For example, the user interface can be configured to let the user click on a measurement specification 28 and automatically display all propagated measurement specifications and/or the measurements obtained by evaluating the propagated measurement specifications 28.

According to an example of the first embodiment of the disclosure, the method 10 comprises using a user interface configured for proposing measurement specifications 28 to a user, which can be accepted, modified or declined by the user, wherein proposals for measurement specifications 28 are generated from measurement specifications 28 previously indicated by the user. For example, if a user indicated a measurement specification for measuring the distance between two indicated contour points 34 of a pair of contours 32, the user interface can transfer the indicated contour points 34 to a neighboring pair of contours 32 of the same type and propose to the user to add the corresponding measurement specification 28. This process can be especially useful in case of repeating semiconductor structures, such as for memory wafers. Alternatively, machine learning methods can be used to predict further measurements specifications 28 based on a given history of user indicated measurement specifications 28, e.g., Markov chains or knowledge graphs. The machine learning model can be trained using histories of indicated measurement specifications 28, either of the same user to obtain personalized predictions, or of different users to obtain general predictions.

According to an example of the first embodiment of the disclosure, the method comprises using a user interface configured for letting a user indicate measurement specifications 28 using natural language processing. For example, descriptions of measurement specifications can be used such as “find the shortest distance between trench number 2 and the closest channel”. Contours 32 in the form of image segments and instance indices are especially useful here, since the user can easily refer to the instance number to define measurement specifications 28.

According to an example of the first embodiment of the disclosure, the method comprises using a visualization device for visualizing features and/or contours and/or measurement specifications 28, wherein the visualization indicates the association of features and/or contours 32 and/or measurement specifications 28 to the semiconductor structures 30. For example, all features and/or contours 32 and/or measurement specifications 28 associated with the same semiconductor structure 30 are visualized in the same way, e.g., using the same color, whereas features and/or contours 32 and/or measurement specifications 28 associated to a different semiconductor structure 30 are visualized in a different way, e.g., using a different color.

According to an example of the first embodiment of the disclosure, the method comprises using a visualization device for visualizing features and/or contours 32 and/or measurement specifications 28, wherein the features and/or contours 32 and/or measurement specifications 28 in the first 2D cross section image 24 are distinguishable from the propagated features and/or contours 32 and/or measurement specifications 28 in the further 2D cross section images 26. For example, the first 2D cross section image 24 can be visualized by an opaque color, whereas the further 2D cross section images 26 are visualized by a translucent color, or vice versa.

According to an example of the first embodiment of the disclosure, the method 10 comprises using a visualization device for visualizing a 3D representation of propagated measurement specifications 28. Instead of visualizing measurement specifications 28 in a number of first and further 2D cross section images 24, 26, the features of the contours 32 in the first and the further 2D cross section images 24, 26 can be visualized in a 3D view. The features of the contours 32 can, for example, be interpolated such that a 3D representation is accomplished. For example, in FIG. 7A the centroids 36 could be interpolated to obtain a 3D line.

According to an example of the first embodiment of the disclosure, the method 10 comprises using a user interface and a visualization device configured for letting a user browse through the 2D cross section images comprising visualized features and/or contours 32 and/or measurement specifications 28.

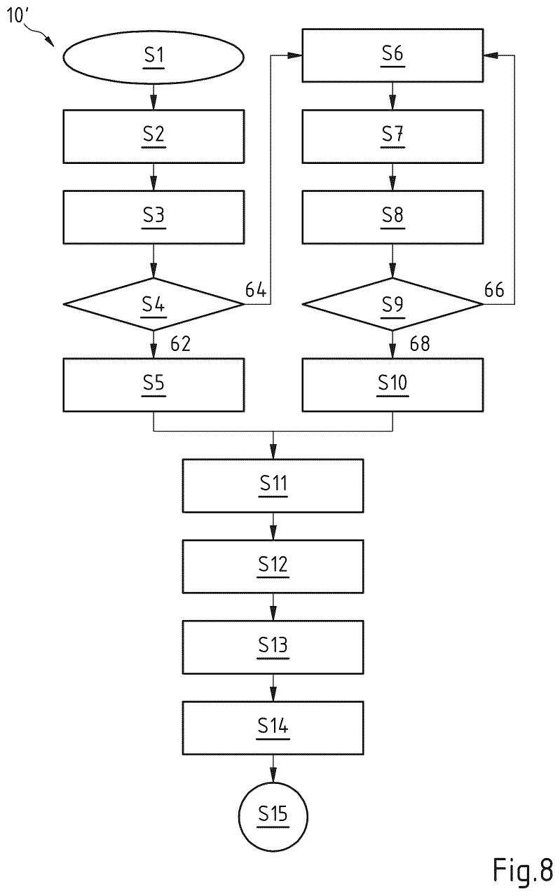

FIG. 8 illustrates a method 10′ according to an example of the first embodiment of the disclosure. In a step S1 a volumetric imaging dataset 22 comprising 2D cross section images is obtained. In a step S2 contours of semiconductor structures in a first 2D cross section image are obtained, e.g., by parsing primitives (for example simple geometric shapes such as circles and rectangles). The contours can, for example, be represented by contour points. Alternatively, an instance segmentation algorithm can be applied to the first 2D cross section image. In a step S3 one or more 2D cross section images are displayed to a user to let the user visually assess the data and determine measurement specifications of interest. In a step S4, a user interface is configured to let the user query a database for a database entry comprising the determined measurement specifications of interest. If such a database entry exists (yes 62), in a step S5 the measurement specifications of the database entry are retrieved from the database. If such a database entry does not exist (no 64), in a step S6 the user interface is configured to let the user indicate a measurement specification with respect to features of the contours obtained in step S2 on a first 2D cross section image of the imaging dataset. In a step S7, the user interface is configured to compute modifications to the selected features of the contours, e.g., by moving indicated contour points to closest points on the contours, or by moving indicated centroids to computed centroids of contours. The centroids can, for example, be computed by the method described with respect to FIG. 6. In a step S8, the indicated measurement specification is saved to a current set of measurement specifications. In a step S9, the user is queried if further measurement specifications are involved. If yes 66, the method proceeds with step S6. If no 68, in a step S10, the current set of measurement specifications is saved to a database. In a step S11, the retrieved set of measurements (after step S5) or the saved current set of measurements (after step S10) are loaded from the database. The measurement specifications are automatically transferred to the first 2D cross section image in a step S12. The measurement specifications are automatically propagated to further 2D cross section images in a step S13 as described above. The measurement specifications can be propagated to all further 2D cross section images or to a selection of further 2D cross section images. A user can be queried to indicate a selection, e.g., by indicating specific 2D cross section images or by indicating a subsampling rate (e.g., every third 2D cross section image). Alternatively, the user interface can automatically select 2D cross section images with respect to a given desired throughput. The measurement specifications can, for example, be propagated to the further 2D cross section images by applying an instance segmentation algorithm to the further 2D cross section images. A tracking algorithm can then be used to track a segmented instance in the first 2D cross section image over the further 2D cross section images to obtain an associated contour in each 2D cross section image. The measurement specifications can be propagated from the first 2D cross section image to the further 2D cross section images by identifying corresponding features of associated contours in the first 2D cross section image and the further 2D cross section images. For example, contour points can be represented by a specific point and a direction vector in the first 2D cross section image as described above with respect to FIG. 4. They can be associated to corresponding contour points in the further 2D cross section images by finding the intersection point of the associated contour and the direction vector starting at a corresponding specific point of the associated contour in the further 2D cross section image as described above. In a step S14 measurements are obtained by evaluating the propagated measurement specifications in the first and the further 2D cross section images. The measurements are displayed to a user, e.g., by listing measurement values or by graphically displaying the measurements within the imaging dataset in a 2D or 3D view, or by displaying a statistical evaluation. Associated contours and/or associated features and/or associated measurement specifications can be indicated using the same approach of representation, e.g., the same color or line type or texture. Optionally, the user interface can be configured to let the user indicate rules for detecting defects, e.g., thresholds or confidence intervals. Alternatively, defects can be detected automatically, e.g., based on statistical methods for detecting outliers or using machine learning methods as described above. Detected defects can be highlighted. In a step S15 the method 10′ ends.

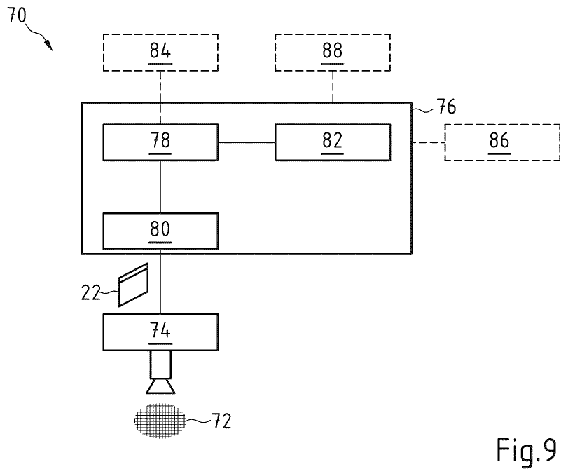

FIG. 9 schematically illustrates a system 70 according to the fourth embodiment of the disclosure, which can be used for obtaining measurements of semiconductor structures on a wafer 72. The system 70 includes an imaging device 74 and a processing device 76.

The imaging device 74 is coupled to the processing device 76, e.g., via cable or wireless. The imaging device 74 is configured to acquire volumetric imaging datasets 22 comprising 2D cross section images of the wafer 72. An example implementation of the imaging device 74 would be a focal ion beam scanning electron microscope (FIB-SEM).

The imaging device 74 can provide an imaging dataset 22 to the processing device 76. The processing device 76 includes a processor 78, e.g., implemented as a CPU or GPU. The processor 78 can receive the imaging dataset 22 via an interface 80. The processor 78 can load program code from a memory 82. The processor 78 can execute the program code. Upon executing the program code, the processor 78 performs techniques such as described herein, e.g., obtaining measurements of semiconductor structures in a wafer, detecting defects in an imaging dataset of a wafer, propagating measurement specifications indicated in a first 2D cross section image to further 2D cross section images, detecting or associating contours and/or features of semiconductor structures in 2D cross section images, training and/or applying a machine learning model for segmentation, object detection, tracking or defect detection, computing centroids of contours of semiconductor structures by analyzing intensity-profiles etc. For example, the processor 78 can perform the method shown in FIG. 1 or FIG. 8, respectively, upon loading program code from the memory 82. The system 70 can optionally contain a user interface 84, e.g., for indicating measurement specifications, rules for defect detection, natural language processing, reviewing associated measurement specifications, etc. The system 70 can optionally contain a database 86. The database 86 can, for example, be used to load sets of measurement specifications, training data or pre-trained machine learning models. The system 70 can optionally contain a visualization device 88 for visualizing measurements and/or measurement specifications and/or defects and/or contour associations and/or feature associations, etc., to the user.

The methods disclosed herein can, for example, be used during research and development or during high volume manufacturing of wafers, or for process window qualification or enhancement. In addition, the methods disclosed herein can also be used for defect detection of X-ray imaging datasets comprising semiconductor structures, e.g., after packaging a semiconductor device for delivery.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The disclosure encompasses the following clauses:
1. A computer implemented method 10 for obtaining measurements of semiconductor structures 30 on a wafer 72, the method comprising:
   a. Obtaining a volumetric imaging dataset 22 of the wafer 72 comprising multiple 2D cross section images 24, 26;
   b. Obtaining contours 32 of semiconductor structures 30 in 2D cross section images 24, 26 of the imaging dataset 22;
   c. Indicating, in a first 2D cross section image 24 of the imaging dataset 22, one or more measurement specifications 28 with respect to features of contours 32 of semiconductor structures 30;
   d. Propagating the indicated one or more measurement specifications 28 in the first 2D cross section image 24 to further 2D cross section images 26 of the imaging dataset 22; and e. Obtaining measurements of semiconductor structures 30 by evaluating the one or more measurement specifications 28 in the first 2D cross section image 24 and in the further 2D cross section images 26 of the imaging dataset 22.
2. The method of clause 1, wherein the measurement specifications 28 are from the group comprising feature position, feature distance, feature size.
3. The method of clause 1 or 2, wherein the features of the contours 32 of the semiconductor structures 30 comprise points, lines or curves defined relative to contours 32 or contour segments of one or more semiconductor structures 30 in the first 2D cross section image 24.
4. The method of clause 3, wherein the features of the contours 32 of the semiconductor structures 30 are from the group comprising points on contours 32 or on contour segments, areas defined by contours 32 or by contour segments, contours or segments of contours 32, centroids 36 of contours 32 or of contour segments.
5. The method of any one of the preceding clauses, wherein the indicated one or more measurement specifications 28 in the first 2D cross section image 24 are propagated to further 2D cross section images 26 of the imaging dataset 22 in step d. by associating the contours 32 of the semiconductor structures 30 in the first 2D cross section image 24 with corresponding contours 32 of the same semiconductor structures 30 in the further 2D cross section images 26, and by associating the features of the contours 32 of the semiconductor structures 30 in the first 2D cross section image 24 with corresponding features in the associated contours of the semiconductor structures 30 in the further 2D cross section images 26.
6. The method of clause 5, wherein the contours 32 of the semiconductor structures 30 in the first 2D cross section image 24 and in the further 2D cross section images 26 are obtained by applying a contour extraction method to the first 2D cross section image 24 and to the further 2D cross section images 26.
7. The method of clause 5, wherein the contours 32 of the semiconductor structures 30 in the first 2D cross section image 24 and in the further 2D cross section images 26 are obtained by applying an object detection or image segmentation algorithm to the first 2D cross section image 24 and to the further 2D cross section images 26.
8. The method of clause 5, wherein the contours 32 of the semiconductor structures 30 in the first 2D cross section image 24 and in the further 2D cross section images 26 are obtained by applying an instance segmentation algorithm to the first 2D cross section image 24 and to the further 2D cross section images 26.
9. The method of any one of clauses 5 to 8, wherein the contours 32 of the semiconductor structures 30 in the first 2D cross section image 24 and in the further 2D cross section images 26 are represented by contour points 34.
10. The method of any one of clauses 5 to 8, wherein the contours 32 of the semiconductor structures 30 in the first 2D cross section image 24 and in the further 2D cross section images 26 are represented by bounding boxes.
11. The method of any one of clauses 5 to 10, wherein associating the contours 32 of the semiconductor structures 30 in the first 2D cross section image 24 to corresponding contours 32 of the same semiconductor structures 30 in the further 2D cross section images 26 comprises computing a mapping of contour points 34 of the semiconductor structures 30 in the first 2D cross section image 24 and contour points 34 of the semiconductor structures 30 in the further 2D cross section images 26.
12. The method of any one of clauses 5 to 10, wherein associating the contours 32 of the semiconductor structures 30 in the first 2D cross section image 24 to corresponding contours 32 of the same semiconductor structures 30 in the further 2D cross section images 26 comprises applying a tracking algorithm or an optical flow algorithm to track the contours 32 of the semiconductor structures 30 in the first 2D cross section image 24 over the further 2D cross section images 26 of the imaging dataset 22.
13. The method of any one of clauses 5 to 10, wherein associating the contours 32 of the semiconductor structures 30 in the first 2D cross section image 24 to corresponding contours 32 of the same semiconductor structures 30 in the further 2D cross section images 26 comprises registering the imaging dataset 22 to a reference imaging dataset with labeled contours.
14. The method of any one of clauses 1 to 4, wherein the contours 32 of the semiconductor structures 30 in the first 2D cross section image 24 and in the further 2D cross section images 26 are obtained by computing a 3D segmentation of the semiconductor structures 30 in the imaging dataset 24 and computing the contours 32 of the segmented semiconductor structures in the first 2D cross section image 24 and in the further 2D cross section images 26 from the 3D segmentation.
15. The method of clause 14, wherein the indicated one or more measurement specifications 28 in the first 2D cross section image 24 are propagated to further 2D cross section images 26 of the imaging dataset 22 in step d. by associating the contours 32 of the semiconductor structures 30 in the first 2D cross section image 24 with corresponding contours 32 of the same 3D segmentation of the same semiconductor structures 30 in the further 2D cross section images 26, and by associating the features of the contours 32 of the semiconductor structures 30 in the first 2D cross section image 24 with corresponding features in the associated contours 32 of the semiconductor structures 30 in the further 2D cross section images 26.
16. The method of any one of clauses 5 to 15, wherein at least one measurement specification 28 comprises a contour point 34 of a contour 32 of a semiconductor structure 30, wherein the contour point 34 is defined by a specific point 38 relative to the contour 32, for example the centroid 36, and a direction vector 40 indicating the direction of the contour point 34 with respect to the specific point 38 in the first 2D cross section image 24, and wherein associating the contour point 34 in the first 2D cross section image 24 with a corresponding contour point 34 of an associated contour 32 in a further 2D cross section image 26 comprises computing the intersection point of the associated contour 32 and the direction vector 40 starting at the specific point 38 of the associated contour 32 in the further 2D cross section image 26.
17. The method of any one of the preceding clauses, wherein at least one measurement specification 28 comprises the computation of a centroid 36 of a contour 32 of a semiconductor structure 30 in one or more 2D cross section images 24, 26, and wherein the centroid 36 is obtained by analyzing intensity profiles 46, 48 along one-dimensional cross sections 54, 56 of a region 44 encompassing the contour 32 in the one or more 2D cross section images 24, 26.
18. The method of any one of the preceding clauses, wherein propagating the indicated one or more measurement specifications 28 in the first 2D cross section image 24 to further 2D cross section images 26 of the imaging dataset 22 in step d. comprises generating a confidence score indicating the reliability of the associated measurement specifications 28 in the first 2D cross section image 24 and the further 2D cross section images 26.
19. The method of any one of the preceding clauses, wherein defects are detected by detecting outliers in measurements obtained by evaluating a measurement specification 28 in the first 2D cross section image 24 and in the further 2D cross section images 26 of the imaging dataset 22.
20. The method of any one of the preceding clauses, wherein a target throughput is obtained, and wherein the number of further 2D cross section images 26 and/or the number of measurement specifications 28 is automatically adapted to meet the target throughput.
21. The method of any one of the preceding clauses, further comprising using a user interface 84 configured for letting a user indicate measurement specifications 28 by selecting one or more features of contours 32 of semiconductor structures 30 on the first 2D cross section image 24 of the imaging dataset 22, and wherein the user interface 84 is configured for assisting the user during the selection of the one or more features by computing modifications to the selected one or more features with respect to the contours 32 of the semiconductor structures 30.
22. The method of any one of the preceding clauses, further comprising using a user interface 84 configured for letting a user load measurement specifications 28 from a memory or database 86 and/or to save measurement specifications 28 to a memory or database 86.
23. The method of any one of the preceding clauses, further comprising using a user interface 84 configured for proposing measurement specifications 28 to a user, which can be accepted, modified or declined by the user, wherein proposals for measurement specifications 28 are generated from measurement specifications 28 previously indicated by the user.
24. The method of any one of the preceding clauses, further comprising using a user interface 84 configured for letting a user indicate measurement specifications 28 via natural language processing.
25. The method of any one of the preceding clauses, wherein the imaging dataset 22 is obtained by a focused ion beam scanning electron microscope.
26. The method of any one of the preceding clauses, wherein the wafer 72 is a memory wafer.
27. A computer-readable medium, having stored thereon a computer program executable by a computing device, the computer program comprising code for executing a method 10 of any one of the preceding clauses.
28. A computer program product comprising instructions which, when the program is executed by a computer, cause the computer to carry out a method 10 of any one of the preceding clauses.
29. A system 70 for obtaining measurements of semiconductor structures 30 on a wafer 72 comprising:
   an imaging device 74 configured to provide a volumetric imaging dataset 22 comprising multiple 2D cross section images 24, 26 of the wafer 72;
   one or more processing devices 76;
   one or more machine-readable hardware storage devices comprising instructions that are executable by one or more processing devices 76 to perform operations comprising any one of the methods 10 of the preceding method clauses.

In summary, the disclosure relates to a method 10 for obtaining measurements of semiconductor structures 30 on a wafer 72 comprising: obtaining a volumetric imaging dataset 22 of the wafer 72 comprising multiple 2D cross section images 24, 26; obtaining contours 32 of semiconductor structures 30 in 2D cross section images 24, 26; indicating, in a first 2D cross section image 24, one or more measurement specifications 28 with respect to features of contours 32 of semiconductor structures 30; propagating the indicated one or more measurement specifications 28 in the first 2D cross section image 24 to further 2D cross section images 26; and obtaining measurements of semiconductor structures 30 by evaluating the one or more measurement specifications 28 in the first 2D cross section image 24 and in the further 2D cross section images 26.

### REFERENCE NUMBER LIST

10 Method
12 Imaging step
14 Contour generation step
16 Measurement specification step
18 Propagation step
20 Measurement step
22 Imaging dataset
24 First 2D cross section image
26 Further 2D cross section image
28 Measurement specification
30, 30′ Semiconductor structure
32, 32′ Contour
34 Contour point
36 Centroid
38 Specific point
40 Direction vector
42 Circle
44 Region
46, 48 Intensity profile
50, 52 Symmetry point
54, 56 One-dimensional cross section
58, 60 Symmetry axis
62 Yes
64 No
66 Yes
68 No
70 System
72 Wafer
74 Imaging device
76 Processing device
78 Processor
80 Interface
82 Memory
84 User interface
86 Database
88 Visualization device

What is claimed is:

1. A computer implemented method, comprising:
a. obtaining a volumetric imaging dataset of a wafer comprising semiconductor features, the volumetric imaging dataset comprising a first 2D cross section image and further 2D cross section images;
b. obtaining contours of the semiconductor structures in the first 2D cross section image and in the further 2D cross section images;
c. indicating, in the first 2D cross section image, a measurement specification with respect to features of the contours of the semiconductor structures;
d. propagating the measurement specification in the first 2D cross section image to the further 2D cross section images; and
e. obtaining measurements of the semiconductor structures by evaluating the measurement specification in the first 2D cross section image and in the further 2D cross section images.

2. The method of claim 1, wherein the measurement specification comprises at least one member selected from the group consisting of a feature position, a feature distance, and a feature size.

3. The method of claim 1, wherein the features of the contours of the semiconductor structures comprise at least one member selected from the group consisting of points on the contours, points on the contour segments, areas defined by the contours, areas defined by the contour segments, the contours, and segments of the contours.

4. The method of claim 1, wherein the measurement specification consists of feature distances, and the features of the contours consist of contour points.

5. The method of claim 1, wherein the contours of the semiconductor structures in the first 2D cross section image and in the further 2D cross section images are obtained by applying an object detection or image segmentation algorithm to the first 2D cross section image and to the further 2D cross section images.

6. The method of claim 1, wherein the contours of the semiconductor structures in the first 2D cross section image and in the further 2D cross section images are obtained by applying an instance segmentation algorithm to the first 2D cross section image and to the further 2D cross section images.

7. The method of claim 1, wherein the contours of the semiconductor structures in the first 2D cross section image and in the further 2D cross section images are represented by contour points.

8. The method of claim 1, wherein the contours of the semiconductor structures in the first 2D cross section image and in the further 2D cross section images are represented by bounding boxes.

9. The method of claim 1, wherein d. comprises associating:
i. the contours of the semiconductor structures in the first 2D cross section image with corresponding contours of the same semiconductor structures in the further 2D cross section images; and
ii. the features of the contours of the semiconductor structures in the first 2D cross section image with corresponding features in the associated contours of the semiconductor structures in the further 2D cross section images.

10. The method of claim 9, wherein i. comprises computing a mapping of contour points of the semiconductor structures in the first 2D cross section image and contour points of the semiconductor structures in the further 2D cross section images.

11. The method of claim 9, wherein i. comprises applying a tracking algorithm or an optical flow algorithm to track the contours of the semiconductor structures in the first 2D cross section image over the further 2D cross section images of the imaging dataset.

12. The method of claim 9, wherein i. comprises registering the imaging dataset to a reference imaging dataset with labeled contours.

13. The method of claim 9, wherein:
the measurement specification comprises a contour point of a contour of a semiconductor structure;
the contour point is defined by a specific point relative to the contour and a direction vector indicating a direction of the contour point with respect to the specific point in the first 2D cross section image; and
associating the contour point in the first 2D cross section image with a corresponding contour point of an associated contour in a further 2D cross section image comprises computing an intersection point of the associated contour and the direction vector starting at the specific point of the associated contour in the further 2D cross section image.

14. The method of claim 1, wherein d. comprises generating a confidence score indicating a reliability of associated measurement specifications in the first 2D cross section image and in the further 2D cross section images.

15. The method of claim 1, wherein defects are detected by detecting outliers in measurements obtained by evaluating a measurement specification in the first 2D cross section image and in the further 2D cross section images.

16. The method of claim 1, further comprising:
providing an inspection target; and
automatically adapting a number of further 2D cross section images and/or a number of measurement specifications to meet the inspection target.

17. The method of claim 1, wherein the measurement specification in the first 2D cross section image is indicated with a user interface.

18. The method of claim 17, wherein the user interface is configured to allow a user to indicate the measurement specification by selecting one or more features of contours of the semiconductor structures in the first 2D cross section image.

19. The method of claim 17, wherein the user interface is configured to automatically compute modifications to selected features of contours of semiconductor structures used to define the measurement specification.

20. The method of claim 1, further comprising using a user interface configured to propose measurement specifications generated from measurement specifications previously indicated by the user, wherein the proposed measurement specifications are configured to be accepted, modified or declined by the user.

21. The method of claim 1, further comprising using a user interface configured to allow a user to indicate measurement specifications via natural language processing.

22. The method of claim 1, further comprising using a focused ion beam scanning electron microscope to obtain the imaging dataset.

23. A computer-readable medium, having stored thereon a computer program executable by a computing device, the computer program comprising code for executing a method (10) of claim 1.

24. One or more machine-readable hardware storage devices comprising instructions that are executable by a computer to perform operations comprising the method of claim 1.

25. A system, comprising:
one or more processing devices; and
one or more machine-readable hardware storage devices comprising instructions that are executable by a computer to perform operations comprising the method of claim 1.

26. The system of claim 25, further comprising an imaging device configured to provide the volumetric imaging dataset.
